(19) United States
(12) Patent Application Publication
(10) Pub. No.: US 2010/0272365 A1
(43) Pub. Date: Oct. 28, 2010

(54) PICTURE PROCESSING METHOD AND PICTURE PROCESSING APPARATUS

(76) Inventors: Koji Yamamoto, Tokyo (JP); Hisashi Aoki, Kanagawa (JP)

Correspondence Address: NIXON & VANDERHYE, PC, 901 NORTH GLEBE ROAD, 11TH FLOOR, ARLINGTON, VA, 22203, US

(21) Appl. No.: 12/734,698

(22) PCT Filed: Nov. 28, 2008
(86) PCT No.: PCT/JP2008/072108

§ 371 Date: May 18, 2010

(30) Foreign Application Priority Data
Nov. 29, 2007 (JP) 2007-308687

(51) Int. Cl. G06K 9/46

(52) U.S. Cl. 382/190

(57) ABSTRACT

Shot groups that include face areas and satisfy a predetermined criterion are selected out of shot groups that are sets of similar shots. Face areas included in the same shot group are classified according to features. A classified face area group included in the same shot group is presumed to be that of the same person and selected as the face area group of a main character. Consequently, the main character is selected by combining similarity of shots forming a picture and face area detection. Therefore, even in a picture including a character whose face cannot be detected in a part of shot sections, it is possible to order and select characters and select a face of a main character more conforming to actual program contents in a television program than that in the related art.

### TECHNICAL FIELD

The present invention relates to a picture processing method and a picture processing apparatus.

### BACKGROUND ART

In recent years, as a technology for analyzing pictures of television programs and the like and presenting contents of the pictures to viewers, a program recording apparatus and the like that can display persons appearing in a program as a list are developed. As a technology for displaying characters as a list, a technology for classifying faces detected in every shot of a picture for each same person and displaying main characters as a list according to the number of times of appearance of the main characters is disclosed (see Patent Document 1).

Patent Document 2 discloses a technique for classifying detected faces into faces for each same person and extracting a representative face image of each of characters.

Patent Document 3 discloses a technique for specifying, based on the number of face images, a person having a highest appearance frequency as a leading character.

All the technologies explained above are technologies for classifying, based on features, detected faces for each of characters. In such classification processing, a method of first detecting a face area in an image, comparing similarity in a feature space after correcting an illumination condition and a three-dimensional shape of the image in the area, and judging whether two faces are faces of the same person is used. For example, Non-Patent Document 1 discloses a picture processing apparatus that performs face-area detection processing at a pre-stage and then performs processing for face feature point detection, normalization of a face area image, and identification by comparison of similarity to a registered face dictionary (identification concerning whether faces are those of the same person).

[Patent Document 1] Japanese Patent No. 3315888

[Patent Document 2] JP-A 2001-167110 (KOKAI)

[Patent Document 3] JP-A 2006-244279 (KOKAI)

[Non-Patent Document 1] Osamu Yamaguchi, et al.: “Face Recognition System “SmartFace” Robust Against a Change in a Face Direction and an Expression”, The Institute of Electronics, Information and Communication Engineers Transaction D-II, Vol. J84-D-II, No. 6, June 2001, pp. 1045-1052

In all the technologies explained above, the processing is performed based on a face detected from a picture. Therefore, in an environment in which a face is not normally detected, a correct result cannot be obtained.

However, in television programs, faces of persons are sometimes not seen because the persons turn away or turn around. Therefore, according to the technologies explained above, there is a problem in that a face of a person in a picture cannot be detected and appearance time and the number of times of appearance of the person cannot be correctly counted.

Unlike an image for face recognition, detected faces of persons in a picture are faces in various directions, faces of various sizes, and faces of various expressions. Therefore, there is a problem in that long processing time is required for normalization and feature point detection for classification.

In addition, even if normalization of the faces is performed, it is difficult to classify a profile and a front face as faces of the same person.

The present invention has been devised in view of the above and it is an object of the present invention to provide a picture processing method and a picture processing apparatus that allows a viewer to order and select characters even if a person whose face cannot be detected in a part of shot sections is included in a picture and can select a face of a main character conforming to actual program contents in a television program.

### DISCLOSURE OF INVENTION

To solve the problems described above and achieve the object, a picture processing method according to the present invention executed by a control unit of a picture processing apparatus, the picture processing apparatus including the control unit and a storing unit, the method includes extracting features of frames as an element of a picture by a feature extraction unit; detecting a cut point as a switching point of a screen between the temporally continuous frames by a cut detecting unit using the features; detecting shots as similar shots to which a same shot attribute value is imparted by similar shot detecting unit, when a difference of the features between the frames is within a predetermined error range, the shots being sources of extraction of the frames and aggregates of the frames in a time section divided by the cut point; selecting a shot group satisfying a predetermined criterion from shot groups as sets of the similar shots by a shot selecting unit; detecting a face area that is an image area presumed to be a face of a person from one or more shots included in the selected shot group by a face-area detecting unit; imparting a same face attribute value to the respective face areas regarded as the same by a face-area tracking unit, when coordinate groups of the face areas between the continuous frames are regarded as the same; and receiving by a face-area selecting unit the coordinate groups of the face areas to which the same face attribute value is imparted from the face-area tracking unit, classifying the face areas included in the same shot group according to the features, presuming the classified face area group included in the same shot group to be that of a same person, and selecting the face area group as a face area group of a main character.

A picture processing method according to the present invention executed by a control unit of a picture processing apparatus, the picture processing apparatus including the control unit and a storing unit, the method includes detecting a face area as an image area presumed to be a face of a person from frames as elements of a picture by a face-area detecting unit; imparting a same face attribute value to the respective face areas regarded as the same, when coordinate groups of the face areas between the continuous frames are regarded as the same, by a face-area tracking unit; extracting features of the frames by a feature extraction unit; detecting a cut point as a switching point of a screen between the temporally continuous frames by a cut detecting unit using the features; detecting shots as similar shots to which a same shot attribute value is imparted by similar shot detecting unit, when a difference of the features between the frames is within a predetermined error range, the shots being sources of extraction of the frames and aggregates of the frames in a time section divided by the cut point; receiving information indicating the frames in which the face areas are detected from the face-area detecting unit by a shot selecting unit, receiving information concerning the similar shots from the similar shot detecting unit, and selecting a shot group that includes the face areas and satisfies a predetermined criterion from shot groups that are sets of the similar shots; and receiving by a face-area selecting unit the coordinate groups of the face areas to which the same face attribute value is given from the face-area tracking unit, receiving the shot area group including the face areas from the shot selecting unit, classifying the face areas included in the same shot group according to the features, presuming the classified face area group included in the same shot group to be that of a same person, and selecting the face area group as a face area group of a main character.

A picture processing apparatus according to the present invention includes a feature extraction unit that extracts features of frames as an element of a picture; a cut detecting unit that detects a cut point as a switching point of a screen between the temporally continuous frames using the features; a similar shot detecting unit that detects shots as similar shots to which a same shot attribute value is imparted, when a difference of the features between the frames is within a predetermined error range, the shots being sources of extraction of the frames and aggregates of the frames in a time section divided by the cut point; a shot selecting unit that selects a shot group satisfying a predetermined criterion from shot groups as sets of the similar shots; a face-area detecting unit that detects a face area that is an image area presumed to be a face of a person from one or more shots included in the selected shot group; a face-area tracking unit that imparts a same face attribute value to the respective face areas regarded as the same, when coordinate groups of the face areas between the continuous frames are regarded as the same; and a face-area selecting unit that receives the coordinate groups of the face areas to which the same face attribute value is imparted from the face-area tracking unit, classifies the face areas included in the same shot group according to the features, presumes the classified face area group included in the same shot group to be that of a same person, and selects the face area group as a face area group of a main character.

### BRIEF DESCRIPTION OF DRAWINGS

FIG. 1 is a block diagram of a configuration of a picture processing apparatus according to a first embodiment of the present invention.

FIG. 2 is a block diagram of a schematic configuration of the picture processing apparatus.

FIG. 3 is a schematic diagram illustrating an example of face area tracking.

FIG. 4 is a schematic diagram illustrating an example of area tracking.

FIG. 5 is a schematic diagram illustrating an example of imparting of face attribute values.

FIG. 6 is a schematic diagram illustrating an example of selection of face areas.

FIG. 7 is a schematic diagram illustrating an example of classification of the face areas.

FIG. 8 is a schematic diagram illustrating an example of a first selection criterion.

FIG. 9 is a schematic diagram illustrating an example of a second selection criterion.

FIG. 10 is a schematic diagram illustrating an example of a third selection criterion.

FIG. 11 is a flowchart of a flow of face detection processing.

FIG. 12 is a schematic diagram illustrating an example of face detection.

FIG. 13 is a block diagram of a schematic configuration of a picture processing apparatus according to a second embodiment of the present invention.

FIG. 14 is a flowchart of a flow of face detection processing.

FIG. 15 is a block diagram of a schematic configuration of a picture processing apparatus according to a third embodiment of the present invention.

FIG. 16 is a schematic diagram illustrating an example in which an attribute indicating another character is imparted to the same person.

FIG. 17 is a flowchart of a flow of face area removal processing.

FIG. 18 is a schematic diagram illustrating a feature extracting method.

### BEST MODE(S) FOR CARRYING OUT THE INVENTION

Best modes of a picture processing method and a picture processing apparatus according to the present invention are explained in detail with reference to the accompanying drawings.

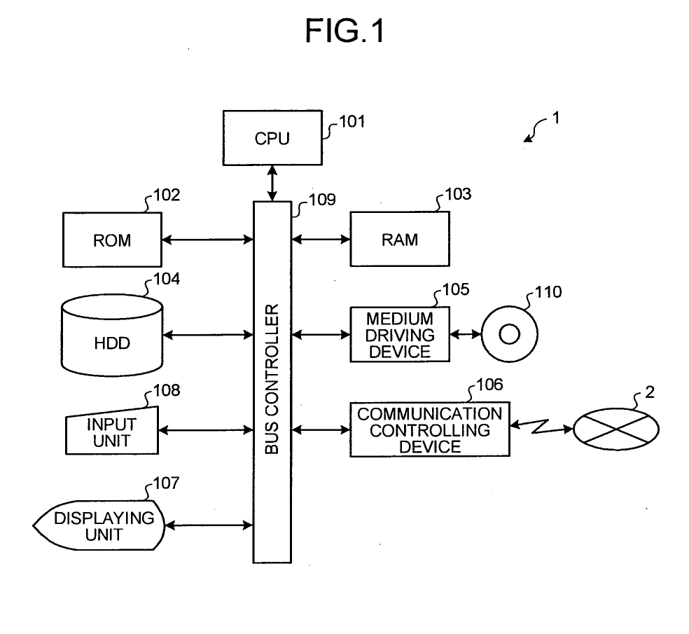

A first embodiment of the present invention will be explained with reference to FIGS. 1 to 12. In the first embodiment, an example in which a personal computer is used as a picture processing apparatus will be explained.

FIG. 1 is a block diagram of a picture processing apparatus 1 according to the first embodiment of the present invention. The picture processing apparatus 1 includes: a Central Processing Unit (CPU) 101 that performs information processing; a Read Only Memory (ROM) 102 that stores therein, for example, a Basic Input/Output System (BIOS); a Random Access Memory (RAM) that stores therein various types of data in a rewritable manner; a Hard Disk Drive (HDD) 104 that functions as various types of databases and also stores therein various types of computer programs (hereinafter, “programs”, unless stated otherwise); a medium driving device 105 such as a Digital Versatile Disk (DVD) drive used for storing information, distributing information to the outside of the picture processing apparatus 1, and obtaining information from the outside of the picture processing apparatus 1, via a storage medium 110; a communication controlling device 106 that transmits and receives information to and from other computers on the outside of the picture processing apparatus 1 through communication via a network 2; a displaying unit 107 such as a Liquid Crystal Display (LCD) that displays progress and results of processing to an operator of the picture processing apparatus 1; and an input unit 108 that is a keyboard and/or a mouse used by the operator for inputting instructions and information to the CPU 101. The picture processing apparatus 1 operates while a bus controller 109 arbitrates the data transmitted and received among these functional units.

In the picture processing apparatus 1, when the user turns on the electric power, the CPU 101 runs a program that is called a loader and is stored in the ROM 102. A program that is called an Operating System (OS) and that manages hardware and software of the computer is read from the HDD 104 into the RAM 103 so that the OS is activated. The OS runs other programs, reads information, and stores information, according to an operation by the user. Typical examples of an OS that are conventionally known include Windows (registered trademark). Operation programs that run on such an OS are called application programs. Application programs include not only programs that operate on a predetermined OS, but also programs that cause an OS to take over execution of a part of various types of processes described later, as well as programs that are contained in a group of program files that constitute predetermined application software or an OS.

In the picture processing apparatus 1, a picture processing program is stored in the HDD 104, as an application program. In this regard, the HDD 104 functions as a storage medium that stores therein the picture processing program.

Also, generally speaking, the application programs to be installed in the HDD 104 included in the picture processing apparatus 1 can be recorded in one or more storage media 110 including various types of optical disks such as DVDs, various types of magneto optical disks, various types of magnetic disks such as flexible disks, and media that use various methods such as semiconductor memories, so that the operation programs recorded on the storage media 110 can be installed into the HDD 104. Thus, storage media 110 that are portable, like optical information recording media such as DVDs and magnetic media such as Floppy Disks (FDs), can also be each used as a storage medium for storing therein the application programs. Further, it is also acceptable to install the application programs into the HDD 104 after obtaining the application programs from, for example, the external network 2 via the communication controlling device 106.

In the picture processing apparatus 1, when the picture processing program that operates on the OS is run, the CPU 101 performs various types of computation processes and controls the functional units in an integrated manner, according to the picture processing program. Of the various types of computation processes performed by the CPU 101 of the picture processing apparatus 1, characteristic processes according to the first embodiment will be explained below.

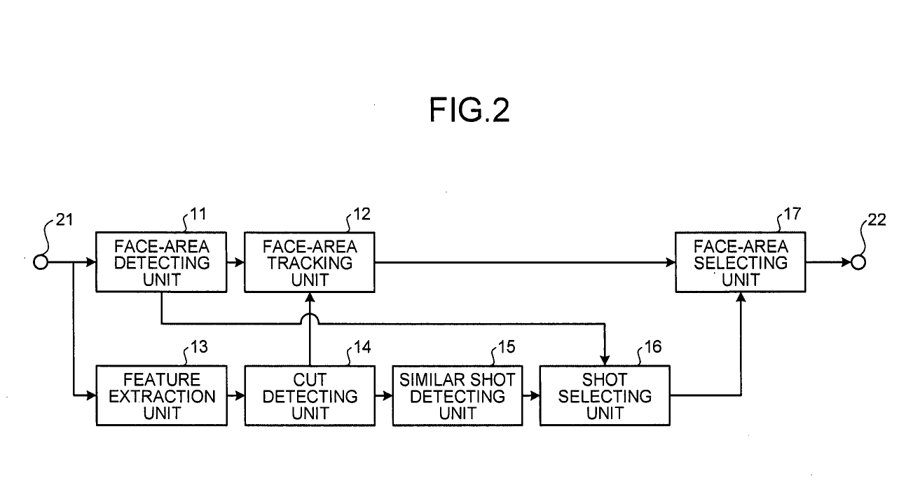

FIG. 2 is a schematic block diagram of the picture processing apparatus 1. As shown in FIG. 2, the picture processing apparatus 1 includes, according to the picture processing program, a face-area detecting unit 11, a face-area tracking unit 12, a feature extraction unit 13, a cut detecting unit 14, a similar shot detecting unit 15, a shot selecting unit 16, and a face-area selecting unit 17. The reference character 21 denotes a picture input terminal, whereas the reference character 22 denotes an attribute information output terminal.

The face area detecting unit 11 detects an image area that is presumed to be a person's face (hereinafter, a “face area”) in a single still image like a photograph or a still image (corresponding to one frame) that is kept in correspondence with a playback time and is a constituent element of a series of moving images, the still image having been input via the picture input terminal 21. To judge whether the still image includes an image area that is presumed to be a person's face and to identify the image, it is possible to use, for example, the method disclosed in MITA et al. “Joint Haar-like Features for Face Detection”, (Proceedings of the Tenth Institute of Electrical and Electronics Engineers [IEEE] International Conference on Computer Vision [ICCV '05], 2005). The method for detecting faces is not limited to the one described above. It is acceptable to use any other face detection method.

The face-area tracking unit 12 tracks a coordinate group of a face area detected by the face-area detecting unit 11 in a target frame and a frame in front of or behind the target frame and judges whether the coordinate group is regarded as the same within a predetermined error range.

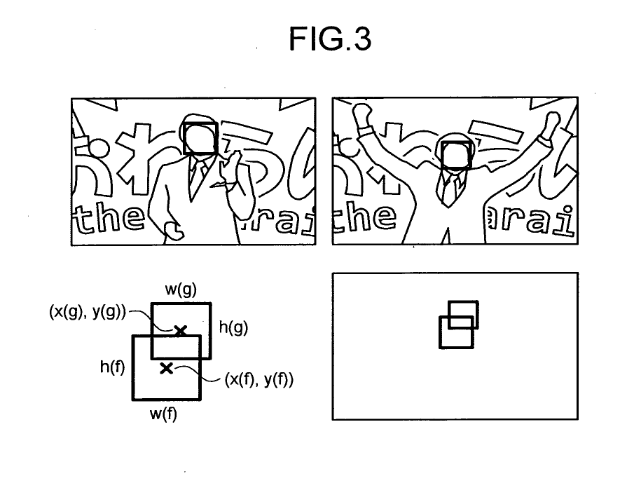

FIG. 3 is a schematic drawing illustrating an example of the face area tracking process. Let us discuss an example in which as many face areas as Nᵢ have been detected from an i'th frame in a series of moving images. In the following explanation, a set of face areas contained in the i'th frame will be referred to as Fᵢ. Each of the face areas will be expressed as a rectangular area by using the coordinates of the center point (x, y), the width (w), and the height (h). A group of coordinates for a j'th face area within the i'th frame will be expressed as x(f), y(f), w(f), h(f), where f is an element of the set Fᵢ(i.e., fεFᵢ). For example, to track the face areas, it is judged whether all of the following three conditions are satisfied: (i) between the two frames, the moving distance of the coordinates of the center point is equal to or smaller than dc; (ii) the change in the width is equal to or smaller than dw; and (iii) the change in the height is equal to or smaller than dh. In this situation, in the case where the following three expressions are satisfied, the face area f and the face area g are presumed to represent the face of mutually the same person: (i) (x(f)−x(g))²+(y(f)−y(g))²≦dc²; (ii) |w(f)−w(g)|≦dw; (iii) |h(f)−h(g)|≦dh. In the expressions above, “| |” is the absolute value symbol. The calculations described above are performed on all of the face areas f that satisfy “fεFᵢ” and all of the face areas g that satisfy “gεFᵢ”.

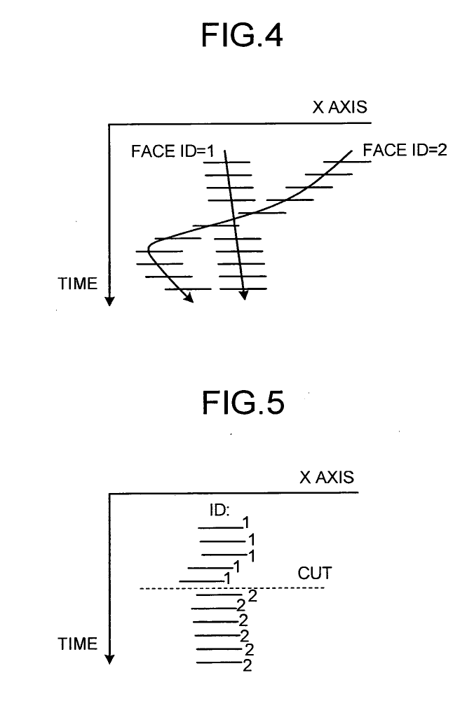

The method for tracking the face areas is not limited to the one described above. It is acceptable to use any other face area tracking methods. For example, in a situation where another person cuts across in front of the camera between the person being in the image and the camera, there is a possibility that the face area tracking method described above may result in an erroneous detection. To solve this problem, another arrangement is acceptable in which, as shown in FIG. 4, the tendency in the movements of each face area is predicted, based on the information of the frames that precede the tracking target frame by two frames or more, so that it is possible to track the face areas while the situation where “someone else cuts in front of the camera” (called “occlusion”) is taken into consideration.

In the face area tracking method described above, rectangular areas are used as the face areas; however, it is acceptable to use areas each having a shape such as a polygon or an oval.

The face-area tracking unit 12 is connected to the cut detecting unit 14 explained later. When there is a cut between two frames set as tracking objects, as shown in FIG. 5, the face-area tracking unit 12 suspends the tracking and judges that a pair of face areas to which the same attribute should be imparted is not present between the two frames.

Subsequently, in the case where a pair of face areas that are presumed to represent the face of mutually the same person have been detected in the two frames as described above, the face-area tracking unit 12 assigns mutually the same face attribute value (i.e., an identifier [ID]) to each of the pair of face areas.

The feature extraction unit 13 extracts a feature of each of the frames out of the single still image like a photograph or the still image (corresponding to one frame) that is kept in correspondence with a playback time and is a constituent element of the series of moving images, the still image having been input via the picture input terminal 21. The feature extraction unit extracts a feature of each of the frames, without performing any process comprehend the structure of the contents (e.g., without performing a face detection process or an object detection process), The extracted feature of each of the frames is used in a cut detection process performed by the cut detecting unit 14 and a similar shot detecting process performed by the similar shot detecting unit 15 in the following steps. Examples of the feature of each of the frames include: an average value of the luminance levels or the colors of the pixels contained in the frame, a histogram thereof, and an optical flow (i.e., a motion vector) in the entire screen area or in a sub-area that is obtained by mechanically dividing the screen area into sections.

By using the features of the frames that have been extracted by the feature extraction unit 13, the cut detecting unit 14 performs the cut detection process to detect a point at which one or more frames have changed drastically among the plurality of frames that are in sequence. The cut detection process denotes a process of detecting whether a switching operation has been performed on the camera between any two frames that are in a temporal sequence. The cut detection process is sometimes referred to as a “scene change detection process”. With regard to television broadcast, a “cut” denotes: a point in time at which the camera that is taking the images to be broadcast on a broadcast wave is switched to another camera; a point in time at which the camera is switched to other pictures that were recorded beforehand; or a point in time at which two mutually different series of pictures that were recorded beforehand are temporally joined together through an editing process. Also, with regard to artificial picture creation processes that use, for example, Computer Graphics (CG) or animations, a point in time at which one image is switched to another is referred to as a “cut”, when the switching reflects an intention of the creator that is similar to the one in the picture creation processes that use natural images as described above. In the description of the first embodiment, a point in time at which an image on the screen is changed to another will be referred to as a “cut” or a “cut point”. One or more pictures in each period of time that is obtained as a result of dividing at a cut will be referred to as a “shot”.

In general, cut detection adopts a method of extracting features such as averages of luminances and colors of pixels included in a frame, histograms of the luminances and the colors, and an optical flow (a motion vector) in an entire screen or small areas, which are formed by mechanically dividing the screen, and judging a point where one or more of the features change between continuous frame as a cut.

Various methods for detecting a cut have been proposed. For example, it is possible to use the method that is disclosed in NAGASAKA et al. “PICTURE sakuhin no bamen gawari no jidou hanbetsuhou”, (Proceedings of the 40th National Convention of Information Processing Society of Japan, pp. 642-643, 1990). The method for detecting a cut is not limited to the one described above. It is acceptable to use any other cut detection method.

The cut point that has been detected by the cut detecting unit 14 as described above is forwarded to the face-area tracking unit 12. The shots that have been obtained as a result of the temporal division performed by the cut detecting unit 14 are forwarded to the similar shot detecting unit 15.

The similar shot detecting unit 15 detects similar shots among the shots that have been obtained as a result of the temporal division and forwarded from the cut detecting unit 14. In this situation, each of the “shots” corresponds to a unit of time period that is shorter than a “situation” or a “scene” such as “a police detective is running down a criminal to a warehouse at a port” or “quiz show contestants are thinking of an answer to Question 1 during the allotted time”. In other words, a “situation”, a “scene”, or a “segment (of a show)” is made up of a plurality of shots. In contrast, shots that have been taken by using mutually the same camera are pictures that are similar to each other on the screen even if they are temporally apart from each other, as long as the position of the camera, the degree of the zoom (i.e., close-up), or the “camera angle” like the direction in which the camera is pointed does not drastically change. In the description of the first embodiment, these pictures that are similar to each other will be referred to as “similar shots”. Also, with regard to the artificial picture creation processes that use, for example, CG or animations, the shots, that have been synthesized as if the images of a rendered object were taken from mutually the same direction while reflecting a similar intention of the creator can be referred to as “similar shots”.

Next, the method for detecting the similar shots that is used by the similar shot detecting unit 15 will be explained in detail. In the similar shot detection process, the features that are the same as the ones used in the cut detection process performed by the cut detecting unit 14 are used. One or more frames are taken out of each of two shots that are to be compared with each other so that the features are compared between the frames. In the case where the difference in the features between the frames is within a predetermined range, the two shots from which the frames have respectively been extracted are judged to be similar shots. When a moving image encoding method such as the Moving Picture Experts Group (MPEG) is used, and in the case where an encoding process is performed by using mutually the same encoder on two shots that are mutually the same or that are extremely similar to each other, there is a possibility that two sets of encoded data that are mutually the same or have a high similarity may be stored. In that situation, it is acceptable to detect similar shots by comparing the two sets of encoded data with each other, without decoding the encoded data.

To detect the similar shots, for example, it is possible to use the method disclosed in JP-A H09-270006 (KOKAI). As an example of another similar-shot detecting method, it is possible to use the method that can be executed at high speed disclosed in Aoki “Television Program Content High-Speed Analysis System by Picture Dialog Detection” (The Institute of Electronics, Information and Communication Engineers Transaction D-II, Vol. J88-D-II, No. 1, January 2005, pp. 17-27). The method for detecting the similar shots is not limited to the one described above. It is acceptable to use any other similar shot detecting method.

By applying the processing to all input images, the same attribute value is imparted to faces of characters in a picture as a coordinate group of face areas having the same attribute over a plurality of frames because of temporal continuity of appearance of the characters. Concerning the picture itself, when there are similar shots in shots divided by cut detection, the same attribute is imparted to the similar shots.

In the processing explained above, concerning a face image, the processing in the face recognition system in the past for performing feature point detection for detecting where portions corresponding to eyes and a nose are present in the image, performing matching with other face areas, registering an area image judges as a face image in a dictionary, or comparing the face image with the dictionary is not performed. The processing up to (2) “FaceDetection” in FIG. 1 of Non-Patent Document 1 explained in the Background Art is merely performed. Such processing can be executed at high speed as disclosed as an example in the thesis of Mita, et al. explained above. In this embodiment, the processing of (3) transfer in FIG. 1 of Non-Patent Document 1 that requires longer time is omitted as face recognition processing.

Characteristic functions provided in the picture processing apparatus 1 according to this embodiment in order to solve the problems explained above are explained.

The shot selecting unit 16 receives, from the face-area detecting unit 11, information indicating in which input frame a face area is detected and receives, from the similar shot detecting unit 15, information concerning a shot including an attribute imparted based on similarity of an entire screen. The shot selecting unit 16 selects, according to a method explained below, a shot in which a main character in a picture is presumed to appear.

A method of selecting a shot in which a main character in a picture is presumed to appear is explained. First, the shot selecting unit 16 sets a set of similar shots, to which the same attribute is imparted, as a shot group and judges whether a face area is included in a shot group unit. However, a shot, an attribute imparted to which is not imparted to other shots, is regarded as independently forming a shot group. A face area only has to be included in any one shot of the shot group. The shot selecting unit 16 selects a shot group in which a face area satisfying predetermined criteria explained later is included. Such processing is performed until a predetermined number of shots are selected or all shots are processed.

Several examples of criteria for selecting a shot are specifically explained.

A first selection criterion is a criterion determining whether the number of shots included in a shot group exceeds a threshold value given in advance. This is because a main character is presumed to often appear in many shots. The criterion is not limited to the number of shots included in a shot group. The length of total time of shots included in a shot group may be used instead of the number of shots. Both the number of shots and the total time of shots can be used. The first selection criterion can be a criterion determining whether one of the number of shots and the total time of shots exceeds a threshold value or a criterion for judging whether both the number of shots and the total time of shots exceed threshold values.

A second selection criterion is a criterion for selecting a predetermined number of shots from the top by arranging all shot groups in advance with reference to the number of shots included in a shot group. The criterion is not limited to the number of shots included in a shot group. The length of total time of shots included in a shot group can be used. Both the number of shots and the total time of shots can be used. When both the number of shots and the total time of shots are used, for example, there is a method of, after once rearranging shot groups according to the number of shots, further rearranging the shot groups in the same order according to the total time or weighting and adding up the shot groups to create a new index.

A main character appears in a picture many times. Therefore, it is also expected that the main character appears over a plurality of shot groups that are not similar shots. In such a case, it is likely that a shot group including the same person is selected many times. Third and fourth selection criteria for making it possible to select various shots are explained below.

The third criterion is a criterion determining whether a similarity between a shot group already selected and a feature of the shot group is lower than a threshold value given in advance. By selecting a shot group according to such a criterion, shots having similar contents are not always selected. It is possible to select various shot groups. As a similarity among shot groups, for example, a similarity calculated by the similar shot detecting unit 15 is used. A similarity obtained by a combination of shots having a largest similarity among shots belonging to shot groups is adopted. A combination which gives the largest similarity can be obtained by calculating through all combinations of shots. A method of extracting a similarity is not limited to this. A similarity can be calculated by using other features.

The fourth selection criterion is a criterion for selecting shot groups such that a sum of levels of similarity of features among all the selected shot groups is minimized or is minimized within a predetermined error range. When a similarity between an i-th shot group and a j-th shot group among selected “n” shot groups is represented as sim(i, j), a sum of levels of similarity is represented by Formula (1) below. A sum of levels of similarity S is calculated for combinations of all shot groups. It is possible to calculate an optimum solution by using a combination of shot groups, the sum of levels of similarity S of which is minimized.

$$Formula 1$$

$$S = {\sum }_{i = 1}^{n} {\sum }_{j = 1}^{n} sim ( i , j ) \qquad ( 1 )$$

A sub-optimum solution can be calculated by an appropriate optimization method such as a hill-climbing method. Entropy (an index indicating randomness) can be used instead of the sum of levels of similarity to select a shot group such that the entropy is maximized.

The specific examples concerning the criterion for selecting shots are explained above. However, the selection criterion is not limited to the examples. A shot group can be selected by using optimum criteria as appropriate.

The face-area selecting unit 17 receives a coordinate group of face areas, which is presumed to be face areas of the same person only because the person is temporally continuously present in the adjacent coordinates and to which the same face attribute is imparted, from the face-area tracking unit 12. The face-area selecting unit 17 also receives information concerning a shot group, which is presumed to include a main character and selected, from the shot selecting unit 16 and selects face areas of the main character with a method explained below.

A method of selecting face areas of a main character is explained. First, the face-area selecting unit 17 classifies face areas included in the same shot group according to features. As the features of face areas, for example, a face area coordinate group is used.

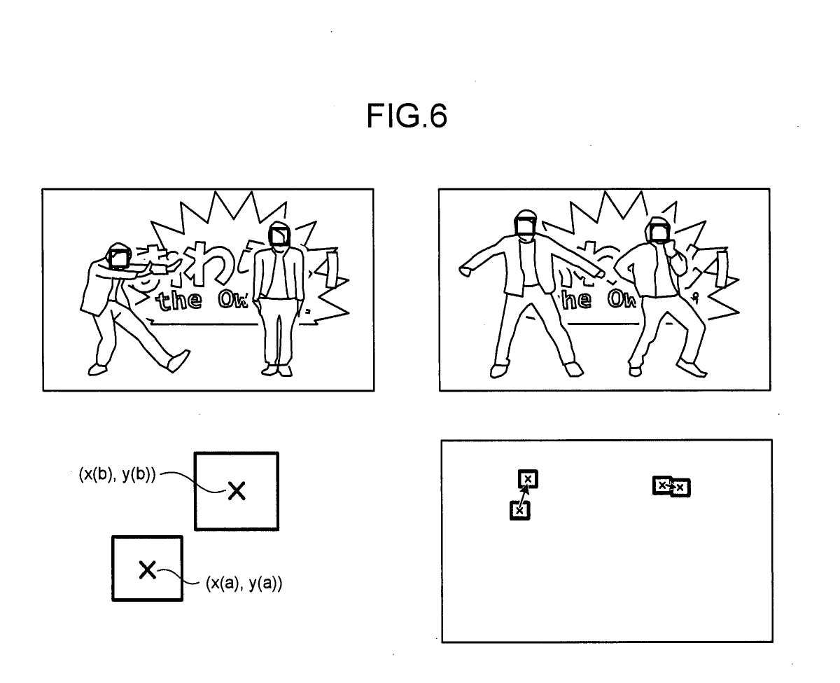

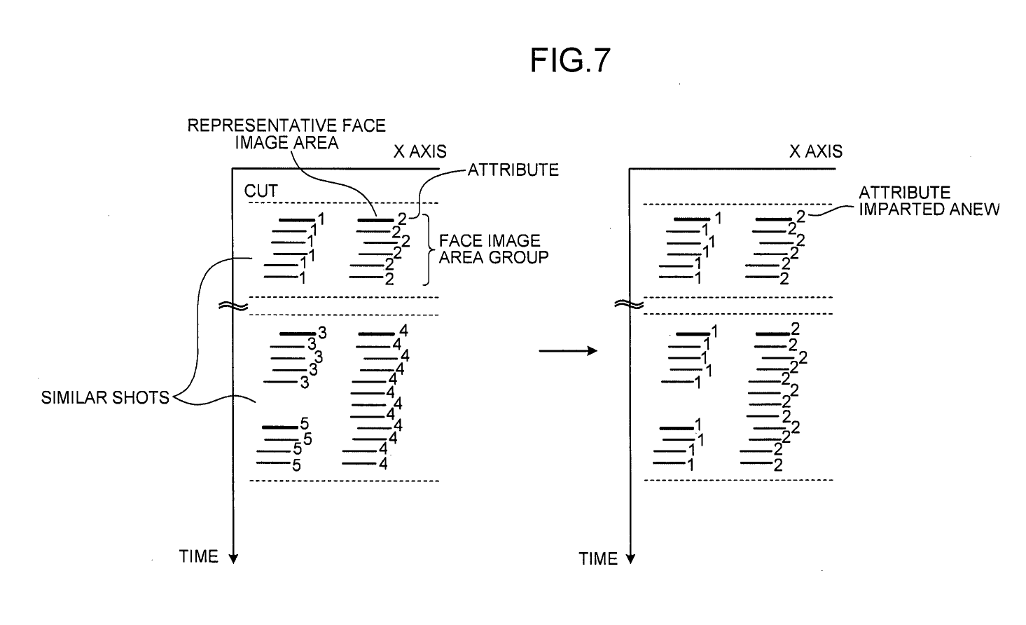

Concerning attributes of face areas, it is not estimated whether the face areas are those of the same person among different shots. When there is only one person in the shots, the person can be presumed to be the same person on condition that the same person appears in similar shots. However, when a plurality of persons are present in shots, it is necessary to classify face areas into face areas for each same person. FIG. 6 is a schematic diagram illustrating an example of selection of face areas performed when a plurality of persons appear. FIG. 7 is a schematic diagram illustrating an example of classification of the face areas. As shown in FIGS. 6 and 7, the face-area selecting unit 17 classifies face areas in positions, center coordinates of which are at a nearest distance, among shots as face areas of the same person. A set of face area groups included in a j-th shot of an i-th shot group is represented as FSᵢⱼ. A face area group unit a series of face areas to which the same attribute is imparted. One face area (e.g., a face area at the top, in the center, at the end, or facing the front most) is selected out of each of the face area groups as a representative of the face area group. In FIG. 6, a face area group pair is extracted from shot groups and center coordinates of representative face areas of the face area groups are represented as (x(a), y(a)) and (x(b), y(b)) (aεFSᵢⱼ, bεFSᵢₖ). Distances are calculated for combinations of all the face area groups between FSᵢⱼ and FSᵢₖ and face area groups in a shortest distance are associated. As an example, a distance can be calculated as (x(a)−x(a))²+(y(b)−y(b))². When faces cannot be detected and face area groups are divided in a shot regardless of the fact that face areas are those of the same person, face area groups in nearest positions in the shot are associated in the same manner. The face area groups associated by the processing explained above are presumed to be those of the same person. Therefore, as shown in FIG. 7, the same attribute is imparted to the face area groups anew. The imparted attribute can be an attribute obtained by correcting an original attribute or can be imparted separately from the original attribute while the original attribute is left. In the example explained above, in the comparison of the face area groups, one face area is selected out of each of the face area groups as a representative of the face area group. However, an average in each of the face area groups can also be used. Further, in the example explained above, the face area coordinate group is used as a feature of face areas. However, an image-like feature calculated by extracting face images from a still image at time corresponding to the face area coordinate group can also be used.

The face-area selecting unit 17 presumes a face area group, which is a series of face areas to which the same attribute is imparted, included in a classified same shot group as that of the same person. When the face area group satisfies a criterion explained later, the face-area selecting unit 17 selects the face area group as a face area group of the main characters.

Such processing is continued until a predetermined number of face area groups are selected or all shots are processed.

Several examples of a selection criterion for a face area group are specifically explained below.

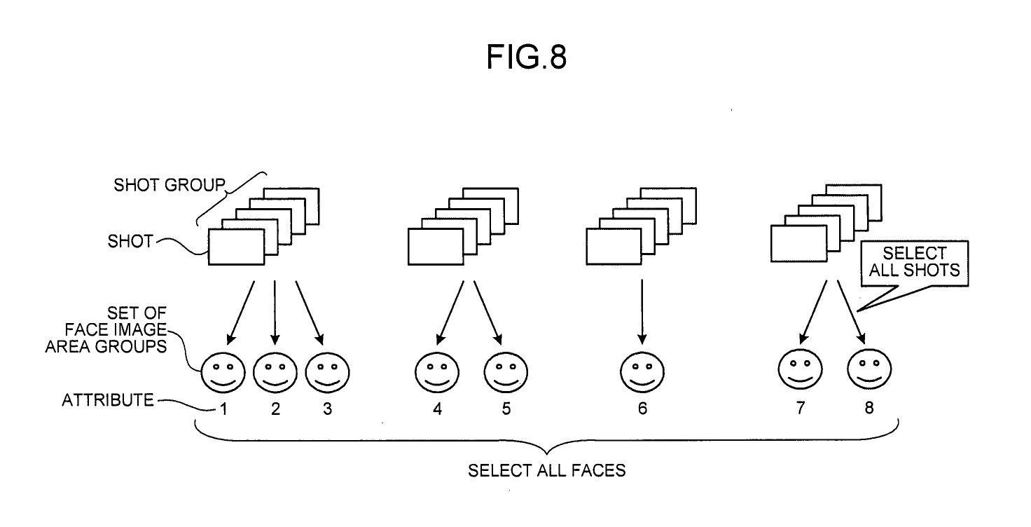

As a first selection criterion, as shown in FIG. 8, all face area groups included in a selected shot group are selected as face area groups of the main character.

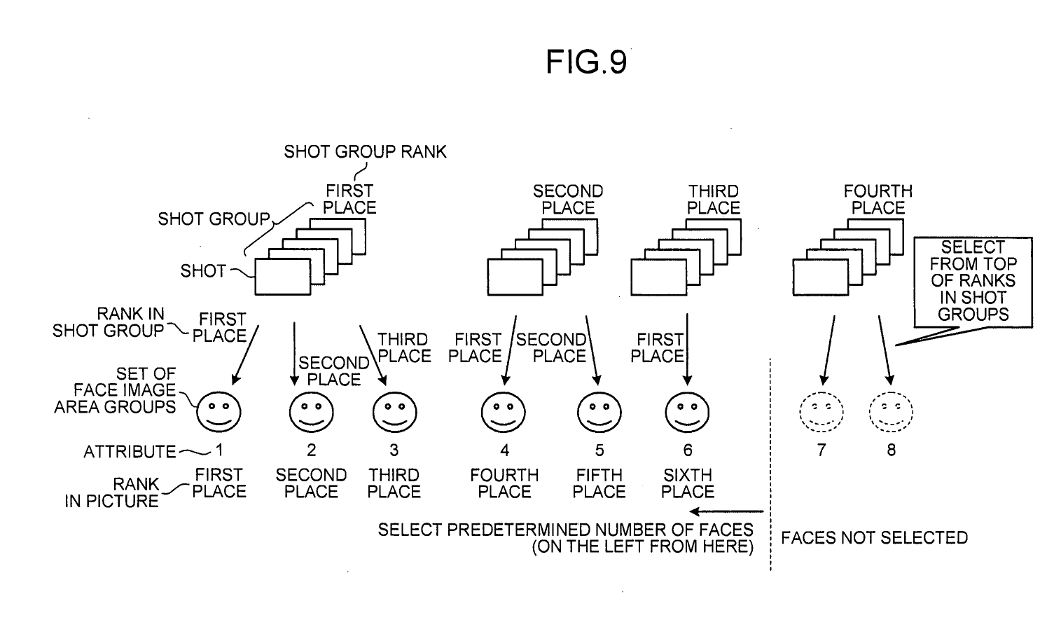

As a second selection criterion, as shown in FIG. 9, when ranks are given to shot groups, a set of face area groups, to which the same attribute is imparted, are rearranged for each of the shot groups and face area groups in higher ranks are selected. This selection is performed based on the ranks of the shot groups. As the rearrangement in shots, for example, the face area groups are arranged in descending order from one having a largest number of face areas included in the set of face area groups. The ranks of the shot groups are given according to the order of selection of the shot groups by the shot selecting unit 16.

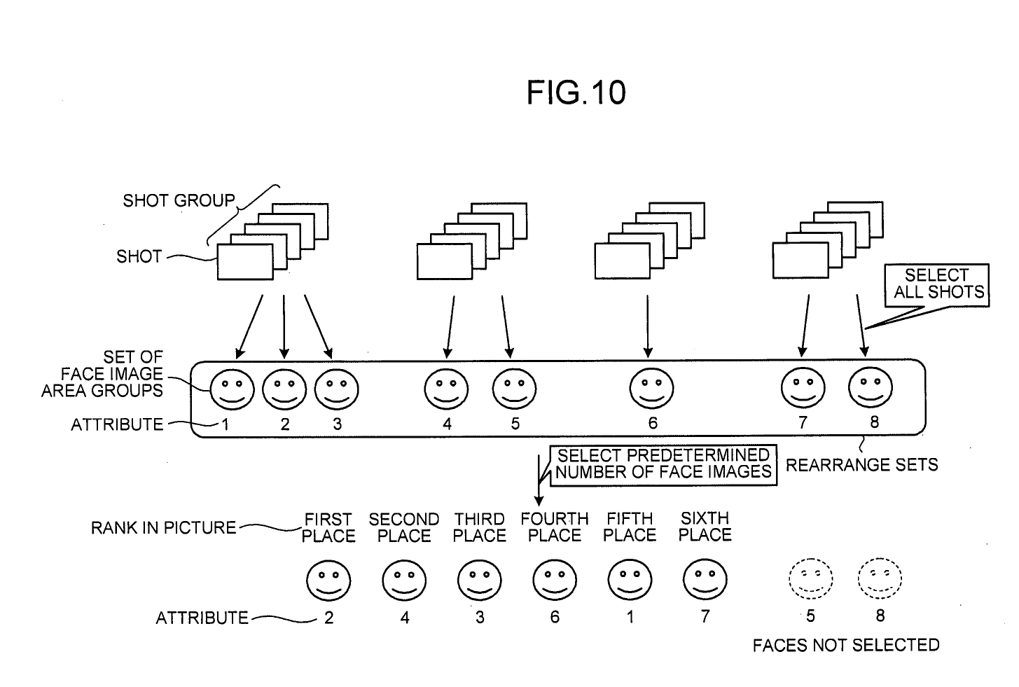

As a third selection criterion, as shown in FIG. 10, a set of face area groups included in selected all shot groups are rearranged and those in higher ranks are selected out of the face area groups. As the rearrangement in shots, for example, the face area groups are arranged in descending order from one having a largest number of face areas included in the set of face area groups.

The face-area selecting unit 17 outputs the face areas, which are presumed to be those of the main character, selected as explained above from an output terminal 22. The output can be a set of face area groups, a face area group selected out of the set of face area groups, or a face area selected out of the face area group. As a criterion for the selection, for example, one at the top temporally or one presumed to face the front most at the time of face detection only has to be selected.

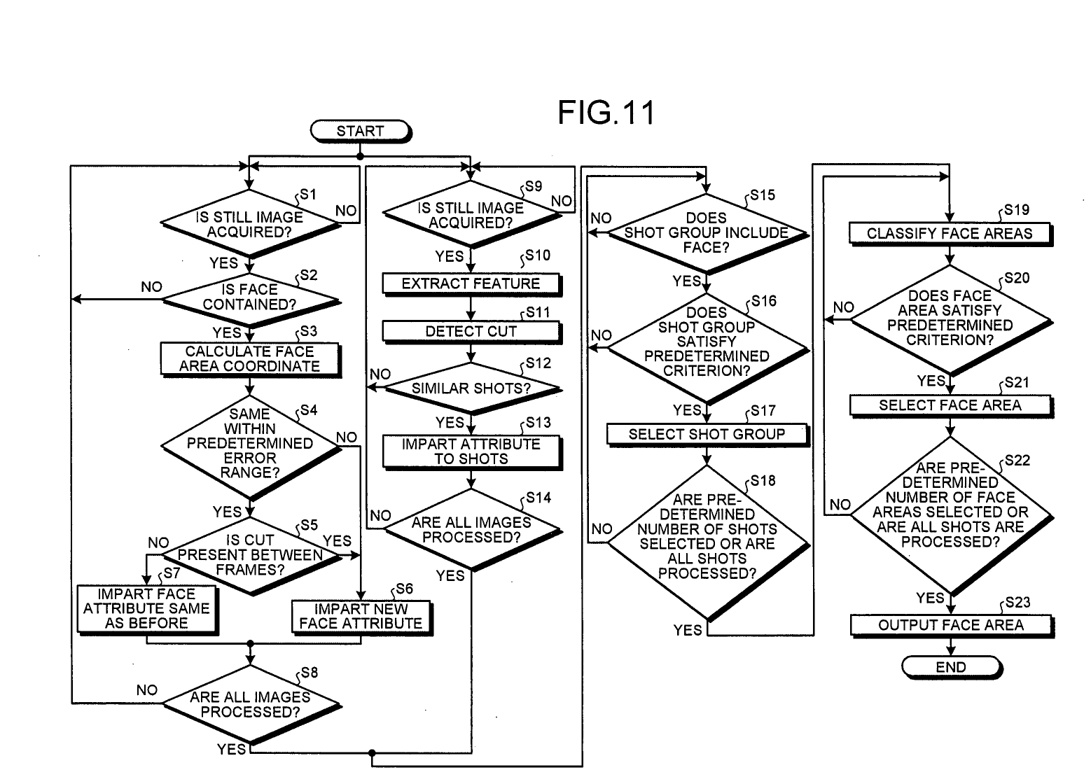

Next, a procedure in a face detection processing that is performed by the CPU 101 of the picture processing apparatus 1 will be explained, with reference to the flowchart in FIG. 11.

As shown in FIG. 11, when a single still image like a photograph or a still image (corresponding to one frame) that is kept in correspondence with a playback time and is a constituent element of a series of moving images has been input to the picture input terminal 21 (step S1: Yes), the input still image is forwarded to the face area detecting unit 11 so that the face area detecting unit 11 judges whether the input still image contains any image area (the face area) that is presumed to be a person's face (step S2). In the case where the face area detecting unit 11 has judged that the still image contains at least one image area (the face area) that is presumed to be a person's face (step S2: Yes), the face area detecting unit 11 calculates a group of coordinates of the face area (step S3). On the other hand, in the case where the face area detecting unit 11 has judged that the still image contains no image area (the face area) that is presumed to be a person's face (step S2: No), the process returns to step S1, and the CPU 101 waits until the next still image is input.

In the following step S4, the face-area tracking unit 12 checks whether coordinate groups of the face areas obtained by the face-area detecting unit 11 in a target frame and a frame in front of or behind the target frame are regarded as the same within a predetermined error range.

When the coordinate groups of the face areas are not regarded as the same within the predetermined error range (“No” at step S4), the face-area tracking unit 12 proceeds to step S6. The face-area tracking unit 12 judges that a pair of face areas, to which the same attribute should be imparted, are not present between the two frames and imparts new face attributes to the face areas, respectively.

When the coordinate groups of the face areas are regarded as the same within the predetermined error range (“Yes” at step S4), the face-area tracking unit 12 proceeds to step S5 and judges whether a cut is present between the tracking-target two frames. When there is a cut between the tracking-target two frames (“Yes” at step S5), the face-area tracking unit 12 suspends the tracking, judges that a pair of face areas, to which the same attribute should be imparted, is not present between the two frames, and imparts new face attributes to the face images, respective (step S6).

On the other hand, when a cut is not present between the tracking-target two frames (“No” at step S5), the face-area tracking unit 12 imparts the same attribute value (ID) to the face areas forming a pair (step S7).

The processing at steps S1 to S7 explained above is repeated until the processing is executed for all input images (“Yes” at step S8).

In the process explained above, faces of characters in a picture are regarded as a coordinate group of face areas having the same attribute over a plurality of frames because of temporal continuity of appearance of the faces and the same attribute value is given to the faces.

On the other hand, a single still image such as a photograph or a still image (one frame), which should be an element of a moving image in association with reproduction time, is input to the picture input terminal 21 (“Yes” at step S9). The feature extraction unit 13 extracts a feature used for cut detection and similar shot detection from the entire image without applying understanding processing (face detection, object detection, etc.) for contents of the image to the image (step S10). The cut detecting unit 14 performs cut detection using the feature of the frame calculated by the feature extraction unit 13 (step S11).

Subsequently, the similar shot detecting unit 15 checks presence of similar shots concerning shots subjected to time division by the cut detecting unit 14 (step S12). When similar shots are present (“Yes” at step S12), the similar shot detecting unit 15 imparts the same attribute (ID) to both the shots judged as similar (step S13). On the other hand, when similar shots are not present (“No” at step S12), the CPU 101 returns to step S9 and stands by for input of the next still image (one frame).

The processing at steps S9 to S13 is repeated until the processing is executed on all input images (“Yes” at step S14).

In the process explained above, concerning a picture, when similar shots are present in the shots divided by the cut detection, the same attribute is imparted to the similar shots.

The processing at steps S1 to S8 and the processing at steps S9 to S14 can be simultaneously performed or can be sequentially performed. However, when an attribute is imparted by using cuts, it is necessary to perform the processing such that the cut detecting unit 14 by the time when the attribute is imparted can obtain relevant cuts relevant cuts can be obtained by the cut detecting unit 14 by the time when the attribute is imparted. When both the kinds of processing are simultaneously performed, step S1 and step S9 can be integrated to simultaneously send an acquired still image to the face-area detecting unit 11 and the feature extraction unit 13.

Subsequently, the shot selecting unit 16 sets a set of the shots, to which the same attribute is imparted, as a shot group and judges whether a face area is included in the shot group unit (step S15). When a face area is included (“Yes” at step S15), the shot selecting unit 16 further judges whether the shot group satisfies a predetermined criterion (step S16). When the shot group satisfies the predetermined criterion (“Yes” at step S16), the shot selecting unit 16 selects the shot group (step S17). On the other hand, when the shot group does not satisfy the predetermined criterion (“No” at step S16), the shot selecting unit 16 returns to step S15 and processes the next shot group.

The processing at steps S15 to S17 explained above is repeated until a predetermined number of shots are selected or all shots are processed (“Yes” at step S18).

The shot selecting unit 16 classifies face areas included in the same shot group according to a feature (step S19) and judges whether a face area satisfies a predetermined criterion (step S20). When the face area satisfies the predetermined criterion (“Yes” at step S20), the shot selecting unit 16 selects the face area as that of a main character (step S21). On the other hand, when the face area does not satisfy the predetermined criterion (“No” at step S20), the shot selecting unit 16 processes the next face area.

The processing at steps S20 to S21 explained above is repeated until a predetermined number of face area groups are selected or all shots are processed (“Yes” at step S22).

When the predetermined number of face area groups are selected or all the shots are processed (“Yes” at step S22), the shot selecting unit 16 outputs the face area presumed to be that of the main character, which is selected as explained above, from the output terminal 22 (step S23) and finishes the processing.

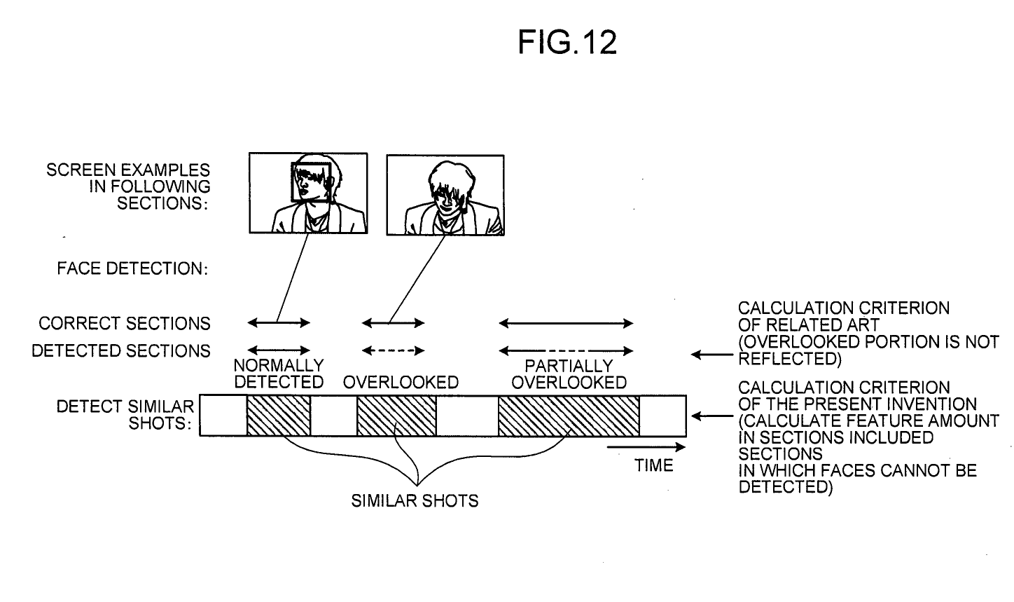

In this way, according to this embodiment, a shot group that includes face areas and satisfies the predetermined criterion is selected out of shot groups as sets of similar shots, face areas included in the same shot group are classified according to a feature, and a face area group included in the classified same shot group is presumed to be that of the same person and selected as a face area group of a main character. In this way, the main character is selected by combining similarity of shots forming a picture and face area detection. Consequently, as shown in FIG. 12, even in a picture including a character whose face cannot be detected in a part of shot sections, it is possible to order and select characters and select a face of a main character more conforming to actual program contents in a television program than that in the related art. Further, the face areas are classified based on general similarity of an entire screen. Therefore, it is unnecessary to perform normalization and feature point detection even if directions and sizes of faces and expressions are different. It is possible to classify the face areas quickly and highly accurately.

As explained above, characters are classified and main characters are specified based on, rather than appearance frequency and time of a face of a person, shots presumed to include the person. This is because, in general, in a television program, it is highly likely that the same person appears in similar shots photographed at the same camera angle.

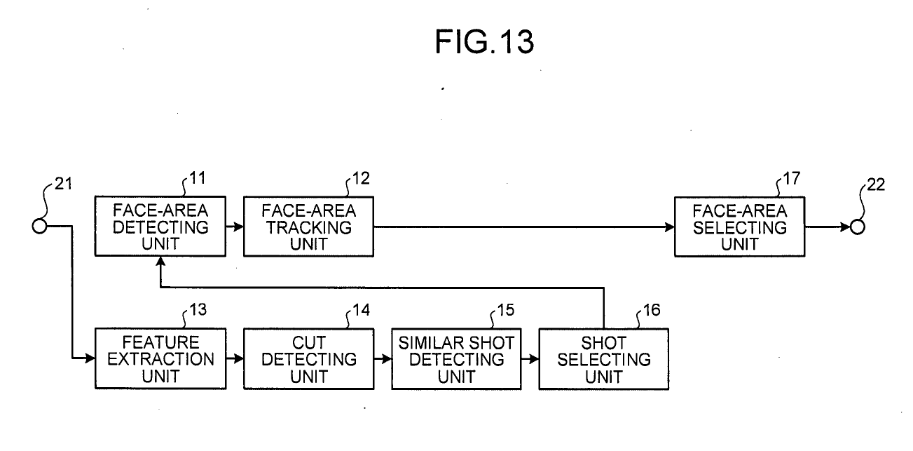

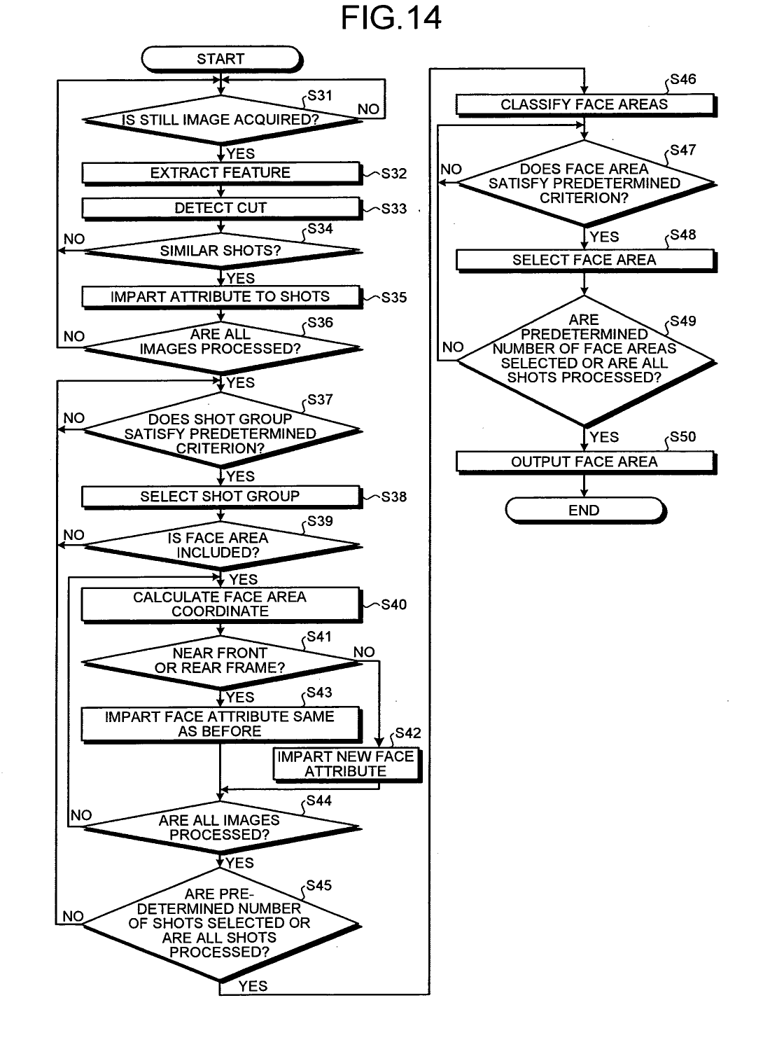

A second embodiment of the present invention is explained below with reference to FIGS. 13 and 14. Components same as those in the first embodiment are denoted by the same reference numerals and signs and explanation of the components is omitted.

This embodiment is different from the first embodiment in a flow of processing. FIG. 13 is a block diagram of a schematic configuration of the picture processing apparatus 1 according to the second embodiment of the present invention. As shown in FIG. 13, the picture processing apparatus 1 includes, according to a picture processing program, the face-area detecting unit 11, the face-area tracking unit 12, the feature extraction unit 13, the cut detecting unit 14, the similar shot detecting unit 15, the shot selecting unit 16, and the face-area selecting unit 17. Reference numeral 21 denotes a picture input terminal and reference numeral 22 denotes an attribute-information output terminal.

The second embodiment is different from the first embodiment in that a shot group that satisfies a predetermined criterion is passed from the shot selecting unit 16 to the face-area detecting unit 11. The face-area detecting unit 11 detects a face area from a still image (one frame) using the shot group, which satisfies the predetermined criterion, passed from the shot selecting unit 16.

A flow of face detection processing executed by the CPU 101 of the picture processing apparatus 1 according to the second embodiment is explained with reference to a flowchart shown in FIG. 14. Operations in the flowchart are different from the operations in the flowchart shown in FIG. 11 in the first embodiment in that face detection and tracking are performed for only a part of input still images. Therefore, a reduction in a processing amount can be expected. It is possible to perform highly accurate processing with a processing amount equivalent to that shown in FIG. 11 by diverting the reduced processing amount to feature point detection and normalization of faces. Most steps in the flowchart shown in FIG. 14 follow those in the flowchart shown in FIG. 11 with the order of processing of the respective steps changed. Therefore, the same processing is only explained briefly.

As shown in FIG. 14, a single still image such as a photograph or a still image (one frame), which should be an element of a moving image in association with reproduction time, is input to the picture input terminal 21 (“Yes” at step S31). The feature extraction unit 13 extracts a feature used for cut detection and similar shot detection from the entire image without applying understanding processing (face detection, object detection, etc.) for contents of the image to the image (step S32). The cut detecting unit 14 performs cut detection using the feature of the frame calculated by the feature extraction unit 13 (step S33).

Subsequently, the similar shot detecting unit 15 checks presence of similar shots concerning shots subjected to time division by the cut detecting unit 14 (step S34). When similar shots are present (“Yes” at step S34), the similar shot detecting unit 15 imparts the same attribute (ID) to both the shots judged as similar (step S35). On the other hand, when similar shots are not present (“No” at step S34), the CPU 101 returns to step S31 and stands by for input of the next still image (one frame).

The processing at steps S31 to S35 is repeated until the processing is executed on all input images (“Yes” at step S36).

In the process explained above, concerning a picture, when similar shots are present in the shots divided by the cut detection, the same attribute is imparted to the similar shots.

Subsequently, the shot selecting unit 16 further judges whether a shot group satisfies a predetermined criterion (step S37). When the shot group satisfies the predetermined criterion (“Yes” at step S37), the shot selecting unit 16 selects the shot group (step S38) and proceeds to step S39. On the other hand, when the shot group does not satisfy the predetermined criterion (“No” at step S37), the shot selecting unit 16 judges the next shot group.

At step S39, the face-area detecting unit 11 judges whether an image area (a face area) presumed to be a face of a person is present in one or more shots included in the selected shot group. When it is judged by the face-area detecting unit 11 that an image area (a face area) presumed to be a face is present (“Yes” at step S39), the face-area detecting unit 11 calculates a coordinate group of the face area (step S40). On the other hand, when it is judged by the face-area detecting unit 11 that an image area (a face area) presumed to be a face is not present (“No” at step S39), the CPU 101 returns to step S37 and stands by for input of the next shot.

In the following step S41, the face-area tracking unit 12 checks whether a coordinate group of the face areas obtained by the face-area detecting unit 11 in a target frame and a frame in front of or behind the target frame are regarded as the same within a predetermined error range.

When the coordinate group of the face areas is not regarded as the same within the predetermined error range (“No” at step S41), the face-area tracking unit 12 proceeds to step S42 and suspends the tracking. The face-area tracking unit 12 judges that a pair of face areas, to which the same attribute should be imparted, are not present between the two frames and imparts new face attributes to the face areas, respectively.

When the coordinate group of the face areas is regarded as the same within the predetermined error range (“Yes” at step S41), the face-area tracking unit 12 proceeds to step S43 and imparts the same attribute value (ID) to the face areas forming a pair.

The processing at steps S41 to S43 explained above is repeated until the processing is executed on all images in the shots (“Yes” at step S44).

The processing at steps S37 to S44 is repeated until a predetermined number of face areas or shots including the face areas are obtained (“Yes” at step S45).

Concerning face areas among shots (when a plurality of shots of the shot group are used at step S39) having different attributes or at separate times in the same shot, it is not presumed whether the face areas are those of the same person. Therefore, first, the face-area selecting unit 17 classifies face areas included in the same shot group according to a coordinate group (step S46) and judges whether a face area satisfies a predetermined criterion (step S47). When the face area satisfies the predetermined criterion (“Yes” at step S47), the face-area selecting unit 17 selects the face area as that of a main character (step S48). On the other hand, when the face area does not satisfy the predetermined criterion (“No” at step S47), the face-area selecting unit 17 processes the next face area.

The processing at steps S47 to S48 is repeated until a predetermined number of face area groups are selected or all shots are processed (“Yes” at step S49).

When the predetermined number of face area groups are selected or all the shots are processed (“Yes” at step S49), the face-area selecting unit 17 outputs faces areas presumed to be those of main characters, which are selected as described above, from the output terminal 22 (step S50) and finishes the processing.

In this way, according to this embodiment, a shot group that satisfies the predetermined criterion is selected out of shot groups as sets of similar shots, face areas as image areas presumed to be faces of persons are detected from one or more shots included in the selected shot group, and, when coordinate groups of face areas between continuous frames are regarded as the same, the same face attribute value is imparted to the respective face areas regarded as the same. Face areas included in the same shot group are classified according to a feature, a classified face area group included in the same shot group is presumed to be that of the same person and selected as a face area group of a main character. In this way, the main character is selected by combining similarity of shots forming a picture and face area detection. Consequently, as shown in FIG. 12, even in a picture including a person whose face cannot be detected in a part of shot sections, it is possible to order and select characters and select a face of a main character more conforming to actual program contents in a television program than that in the related art. Further, the face areas are classified based on general similarity of an entire screen. Therefore, it is unnecessary to perform normalization and feature point detection even if directions and sizes of faces and expressions are different. It is possible to classify the face areas quickly and highly accurately.

As explained above, characters are classified and main characters are specified based on, rather than appearance frequency and time of a face of a person, shots presumed to include the person. This is because, in general, in a television program, it is highly likely that the same person appears in similar shots photographed at the same camera angle.

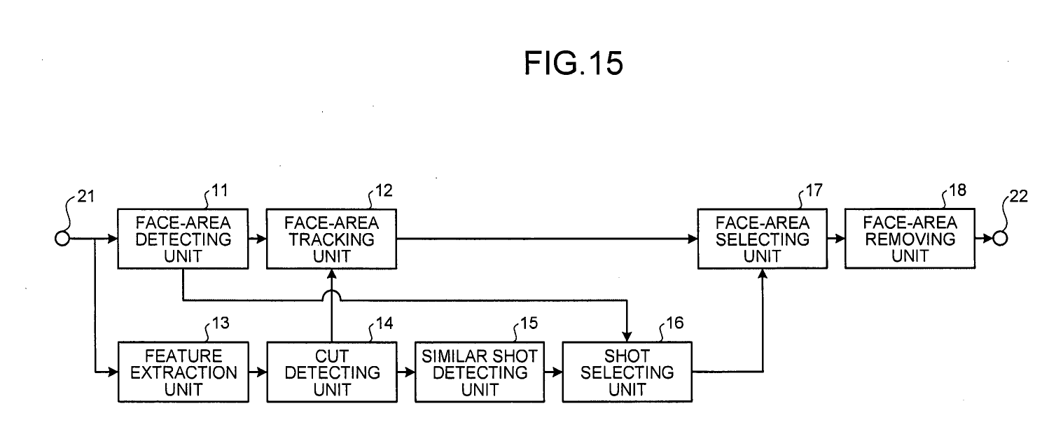

A third embodiment of the present invention is explained below with reference to FIGS. 15 to 18. Components same as those in the first embodiment are denoted by the same reference numerals and signs and explanation of the components is omitted.

FIG. 15 is a block diagram of a schematic configuration of the picture processing apparatus 1 according to the third embodiment. As shown in FIG. 15, the picture processing apparatus 1 includes, according to a picture processing program, the face-area detecting unit 11, the face-area tracking unit 12, the feature extraction unit 13, the cut detecting unit 14, the similar shot detecting unit 15, the shot selecting unit 16, the face-area selecting unit 17, and a face-area removing unit 18. Reference numeral 21 denotes a picture input terminal and reference numeral 22 denotes an attribute-information output terminal.

As shown in FIG. 15, in this embodiment, the face-area removing unit 18 is added to the picture processing apparatus 1 according to the first embodiment. The third embodiment is the same as the first embodiment except operations related to the face-area removing unit 18. Therefore, explanation of components same as those in the first embodiment is omitted.

As shown in FIG. 15, information concerning face areas presumed to be those of main characters by the face-area selecting unit 17 is sent to the face-area removing unit 18.

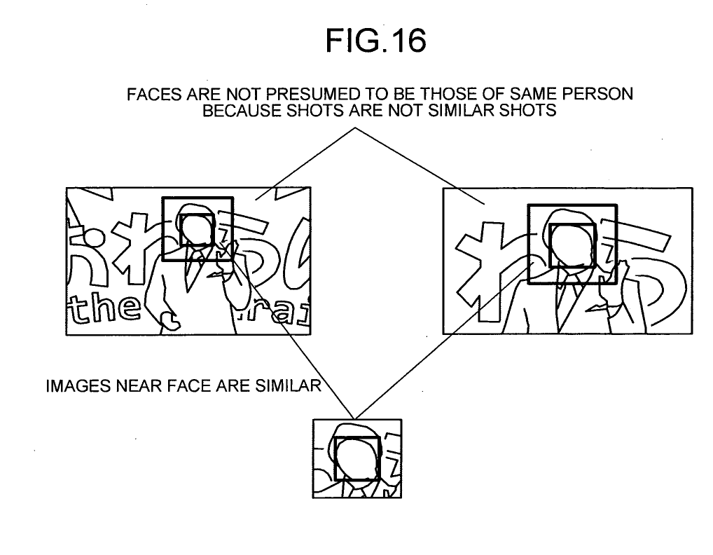

The same attribute is imparted to face areas presumed to be those of the same person. Judgment on the face areas presumed to be those of the same person is performed based on information concerning similar shots obtained by the similar shot detecting unit 15. However, even if the same person is photographed from similar directions, it is likely that shots are not judged as similar shots by the similar shot detecting unit 15 because of a difference in an angle of view and the like and, as shown in FIG. 16, an attribute indicating another person is imparted to face areas. In the case of such a shot, both the shots are similar when attention is paid to images near the face areas. Therefore, according to processing in the face-area removing unit 18 explained below, face areas not detected as similar shots by the similar shot detecting unit 15 but presumed to be those of the same person because of the similarity of images near the face areas are removed from the face areas selected by the face-area selecting unit 17.

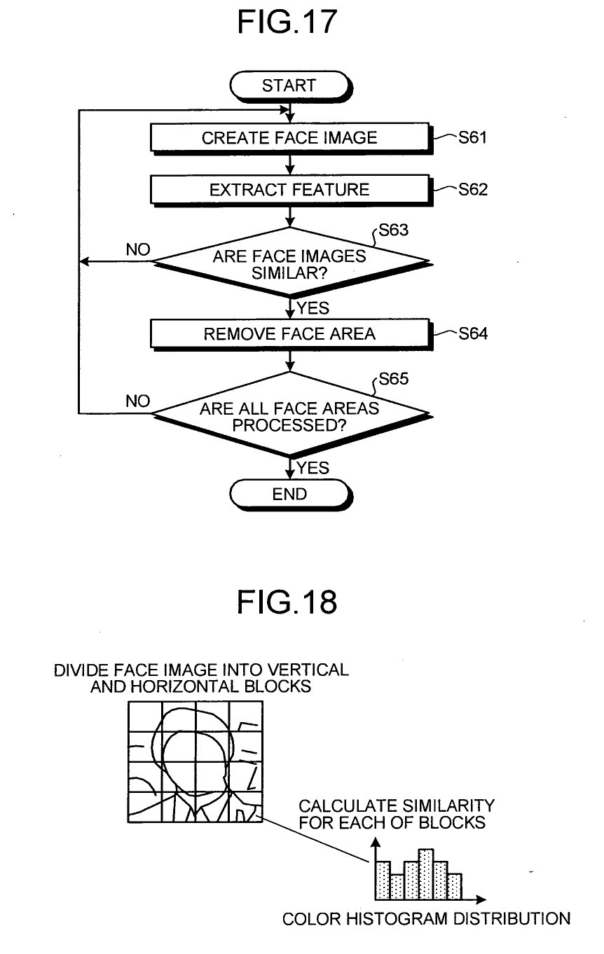

FIG. 17 is a flowchart of a flow of face-area removal processing in the face-area removing unit 18. As shown in FIG. 17, first, the face-area removing unit 18 creates, based on a coordinate group of face areas, a face image including the face areas from a still image temporally corresponding to the coordinate group (step S61) and extracts a feature from the face image (step S62). As an example, the feature is extracted by, as shown in FIG. 18, dividing a face image into vertical and horizontal blocks, calculating a ratio of a portion where histograms overlap, which is called histogram intersection, as a similarity for each of the blocks using a histogram distribution of color components obtained from the respective blocks, and adding up ratios for all the blocks. In adding up the ratios, weight can be changed according to a block. For example, the weight of the center including more face portions is set higher than that of the periphery.

Subsequently, the face-area removing unit 18 calculates a similarity from a face image and a feature obtained from another face area group and judges whether the similarity is a predetermined similarity (step S63). When the similarity is the predetermined similarity, i.e., the face images are similar (“Yes” at step S63), the face-area removing unit 18 removes one face area group (step S64). On the other hand, when the face images are not similar (“No” at step S63), the face-area removing unit 18 returns to step S61. The processing at steps S61 to S64 explained above is repeated until the processing is executed on all pairs of face area groups (“Yes” at step S65).

In this way, according to this embodiment, it is possible to eliminate a face area group that is not judged as similar shots by the similar shot detecting unit because of a difference in an angle of view and the like even if the same person is photographed from similar directions and to which an attribute indicating another person is imparted. Therefore, it is possible to highly accurately classify face areas.

According to the present invention, a shot group that satisfies the predetermined criterion is selected out of shot groups as sets of similar shots, face areas as image areas presumed to be faces of persons are detected from one or more shots included in the selected shot group, and, when coordinate groups of face areas between continuous frames are regarded as the same, the same face attribute value is imparted to the respective face areas regarded as the same. Face areas included in the same shot group are classified according to a feature, a classified face area group included in the same shot group is presumed to be that of the same person and selected as a face area group of a main character. In this way, the main character is selected by combining similarity of shots forming a picture and face area detection. Consequently, there is an effect that even in a picture including a person whose face cannot be detected in a part of shot sections, it is possible to order and select characters and select a face of a main character more conforming to actual program contents in a television program than that in the related art. Further, the face areas are classified based on general similarity of an entire screen. Therefore, there is an effect that it is unnecessary to perform normalization and feature point detection even if directions and sizes of faces and expressions are different and it is possible to classify the face areas quickly and highly accurately.

Further, according to the present invention, a shot group that includes face areas and satisfies the predetermined criterion is selected out of shot groups as sets of similar shots, face areas included in the same shot group are classified according to a feature, and a face area group included in the classified same shot group is presumed to be that of the same person and selected as a face area group of a main character. In this way, the main character is selected by combining similarity of shots forming a picture and face area detection. Consequently, there is an effect that, even in a picture including a character whose face cannot be detected in a part of shot sections, it is possible to order and select characters and select a face of a main character more conforming to actual program contents in a television program than that in the related art. Further, the face areas are classified based on general similarity of an entire screen. Therefore, there is an effect that it is unnecessary to perform normalization and feature point detection even if directions and sizes of faces and expressions are different and it is possible to classify the face areas quickly and highly accurately.

1. A picture processing method executed by a control unit of a picture processing apparatus, the picture processing apparatus including the control unit and a storing unit, the method comprising:
extracting features of frames as an element of a picture by a feature extraction unit;
detecting a cut point as a switching point of a screen between the temporally continuous frames by a cut detecting unit using the features;
detecting shots as similar shots to which a same shot attribute value is imparted by similar shot detecting unit, when a difference of the features between the frames is within a predetermined error range, the shots being sources of extraction of the frames and aggregates of the frames in a time section divided by the cut point;
selecting a shot group satisfying a predetermined criterion from shot groups as sets of the similar shots by a shot selecting unit;
detecting a face area that is an image area presumed to be a face of a person from one or more shots included in the selected shot group by a face-area detecting unit;
imparting a same face attribute value to the respective face areas regarded as the same by a face-area tracking unit, when coordinate groups of the face areas between the continuous frames are regarded as the same; and
receiving by a face-area selecting unit the coordinate groups of the face areas to which the same face attribute value is imparted from the face-area tracking unit, classifying the face areas included in the same shot group according to the features, presuming the classified face area group included in the same shot group to be that of a same person, and selecting the face area group as a face area group of a main character.

2. A picture processing method executed by a control unit of a picture processing apparatus, the picture processing apparatus including the control unit and a storing unit, the method comprising:
detecting a face area as an image area presumed to be a face of a person from frames as elements of a picture by a face-area detecting unit;
imparting a same face attribute value to the respective face areas regarded as the same, when coordinate groups of the face areas between the continuous frames are regarded as the same, by a face-area tracking unit;
extracting features of the frames by a feature extraction unit;
detecting a cut point as a switching point of a screen between the temporally continuous frames by a cut detecting unit using the features;
detecting shots as similar shots to which a same shot attribute value is imparted by similar shot detecting unit, when a difference of the features between the frames is within a predetermined error range, the shots being sources of extraction of the frames and aggregates of the frames in a time section divided by the cut point;
receiving information indicating the frames in which the face areas are detected from the face-area detecting unit by a shot selecting unit, receiving information concerning the similar shots from the similar shot detecting unit, and selecting a shot group that includes the face areas and satisfies a predetermined criterion from shot groups that are sets of the similar shots; and
receiving by a face-area selecting unit the coordinate groups of the face areas to which the same face attribute value is given from the face-area tracking unit, receiving the shot group including the face areas from the shot selecting unit, classifying the face areas included in the same shot group according to the features, presuming the classified face area group included in the same shot group to be that of a same person, and selecting the face area group as a face area group of a main character.

3. The method according to claim 1, wherein the shot selecting unit sets a criterion that at least one of a number of shots included in the shot group and length of total time of the shots included in the shot group exceeds a threshold value given in advance.

4. The method according to claim 1, wherein the shot selecting unit rearranges all the shot groups in advance based on at least one of a number of shots included in the shot group and length of total time of the shots included in the shot group, and sets a criterion that the shot groups are located in a predetermined position from a top.

5. The method according to claim 1, wherein the shot selecting unit sets a criterion determining whether a similarity of features between the shot group and the shot group already selected is smaller than a threshold value given in advance.

6. The method according to claim 1, wherein the shot selecting unit sets a criterion that a sum of levels of similarity of features among all the selected shot groups is minimized or is minimized within a predetermined error range.

7. The method according to claim 1, wherein the face-area selecting unit rearranges sets of the face area groups to which a same attribute is imparted according to ranks of the shot groups for each of the shot groups, and selects a set having a higher rank.

8. The method according to claim 7, wherein the face-area selecting unit rearranges the sets of the face area groups according to ranks of the shot groups selected by the shot selecting unit.

9. The method according to claim 1, wherein the face-area selecting unit rearranges sets of the face area groups included in all the shot groups selected by the shot selecting unit, and selects a set having a higher rank.

10. The method according to claim 9, wherein the face-area selecting unit rearranges the sets of the face area groups in a descending order from one having a largest number of the face areas included in the sets of the face area groups.

11. The method according to claim 1, wherein the face-area selecting unit presumes, when a plurality of the face areas are present in the classified same shot group, the face areas, center coordinates of which are at a nearest distance, among shots to be face areas of a same person.

12. The method according to claim 1, further comprising leaving by a face-area removing unit only one of the face area groups and removing the other image area groups from the face area groups selected by the face-area selecting unit, with respect to a plurality of the face area groups not detected as the similar shots by the similar shot detecting unit but presumed to be those of a same person with similarity of images near the face areas.

13. A picture processing apparatus comprising:
a feature extraction unit that extracts features of frames as an element of a picture;
a cut detecting unit that detects a cut point as a switching point of a screen between the temporally continuous frames using the features;
a similar shot detecting unit that detects shots as similar shots to which a same shot attribute value is imparted, when a difference of the features between the frames is within a predetermined error range, the shots being sources of extraction of the frames and aggregates of the frames in a time section divided by the cut point;
a shot selecting unit that selects a shot group satisfying a predetermined criterion from shot groups as sets of the similar shots;
a face-area detecting unit that detects a face area that is an image area presumed to be a face of a person from one or more shots included in the selected shot group;
a face-area tracking unit that imparts a same face attribute value to the respective face areas regarded as the same, when coordinate groups of the face areas between the continuous frames are regarded as the same; and
a face-area selecting unit that receives the coordinate groups of the face areas to which the same face attribute value is imparted from the face-area tracking unit, classifies the face areas included in the same shot group according to the features, presumes the classified face area group included in the same shot group to be that of a same person, and selects the face area group as a face area group of a main character.
